(19) United States
(12) Patent Application Publication
(10) Pub. No.: US 2010/0003637 A1
(43) Pub. Date: Jan. 7, 2010

(54) Dental File with Improved Tip Configuration

(76) Inventor: William B. Johnson, Tulsa, OK (US)

Correspondence Address: GABLE & GOTWALS, 100 WEST FIFTH STREET, 10TH FLOOR, TULSA, OK, 74103, US

(21) Appl. No.: 12/167,905

(22) Filed: Jul. 3, 2008

(51) Int. Cl. A61C 5/02

(52) U.S. Cl. 433/102

(57) ABSTRACT

A dental instrument for cleaning and shaping a root canal of a tooth includes a working portion having three helical flutes and a guide tip with a first, second, and third face surface. A portion of the guide tip is removed so that each of the first and second surfaces are contiguous to a lateral surface of a conical-shaped envelope defining the original tip but a portion of the third surface is not contiguous to a lateral surface of the conical-shaped envelope. The intersection of the first and second surfaces, however, remains at the center point of the guide tip. The removed portion of the guide tip may result in an arcuate-shaped face surface, an angular-shaped face surface, or some combination of the two.

### REFERENCE TO PENDING APPLICATIONS

This application is not based upon any pending domestic or international patent applications.

### BACKGROUND OF THE INVENTION

1. Field of the Invention

This invention relates generally to the field of dentistry and more particularly to endodontic files or reamers used in the cleaning of material present in the root canal of human teeth and for enlarging and shaping the root canal so that it is prepared for receiving filling material.

2. Description of the Related Art

A relatively common but yet difficult procedure is that of cleaning, shaping, and filling the root canal of a patient's tooth. In the performance of the typical root canal procedure, a hole is first drilled in the crown or the exposed portion of the tooth. The hole drilled through the crown provides access to the interior of the tooth and specifically access to the tooth root canal or root canals. In order to treat the tooth, the canal or canals must be thoroughly cleaned of pulpal material that, in the case of an abscessed tooth, is typically infected. The clinician must remove this pulpal material to alleviate the infection. Next, the clinician must clean and shape the root canal so that it can be effectively filled with a filler material, such as gutta percha.

Much work has been done on the instrumentation needed for effective cleaning, shaping, and filling of a tooth root canal. One such instrument, the endodontic file, is an elongated device insertable into the root canal and manipulated either manually or by machine to clean and shape the root canal. The file removes pulpal material from the interior of the tooth and enlarges and shapes the root canal so that it can be more effectively filled with a filler material

Because root canal paths vary in their geometry and topography, the clinician must choose the appropriate file to precisely control the preparation shape, length, and width of the canal. Prior art endodontic files, however, generally include tip configurations that have face surfaces which engage a relatively large contact area in comparison to the cross-sectional area of the file. The large contact area of the tip unnecessarily produces resistance that may cause file breakage. As the large contact area encounters various surface irregularities and projections, progression of the file as it is rotated into the root canal is impeded. Because almost all of the cutting or scraping occurs at the periphery of the file, these face surfaces may be significantly reduced and yet still provide a file that produces the desired shape of the canal. Therefore, a need exists for a file having a tip configuration with a reduced cross-sectional contact area of the face surfaces.

### BRIEF SUMMARY OF THE INVENTION

A dental instrument for enlarging a root canal of a tooth includes a longitudinal body having a central axis of rotation, three helical-shaped flutes, and a guide tip having a reduced area of contact. In a preferred embodiment, the guide tip is defined by a conical-shaped envelope coaxial with the longitudinal body and has three face surfaces. Each of the first and second surfaces lies substantially contiguous to an opposing lateral surface of the conical-shaped envelope.

A portion of the guide tip is removed so that a portion of the third surface is noncontiguous to an opposing lateral surface of the conical-shaped envelope. The removed portion of the guide tip may be defined by a radius “r” to give the third surface an arcuate-shaped profile. Radius “r” should not extend past the central longitudinal axis of the file in order to keep the apex of the guide tip centered. In another preferred embodiment, the removed portion of the guide tip is defined by an angle “α”. In yet another preferred embodiment, the removed portion of the guide tip is further defined by an angle “β”.

The dental instrument may also include a plurality of helical-shaped flutes and a guide tip having a plurality of face surfaces, at least one of which has a reduced area of contact. The face surface having the reduced area of contact may be defined by a radius “r”, an angle “α”, an angle “β”, or some combination of radius “r” and angles “α” and “β”. A portion of the face surface having the reduced area of contact does not lie contiguous to an opposing lateral surface of the conical-shaped envelope defining the tip. A portion of the other faces surfaces, however, remain contiguous to the envelope. The conical-shaped envelope defining the tip is coaxial to the central longitudinal axis of the instrument and, therefore, shares an apex of at least one of the face surfaces.

A better understanding of the invention will be obtained from the following detailed description of the preferred embodiments and claims, taken in conjunction with the attached drawings.

### BRIEF DESCRIPTION OF THE DRAWINGS

FIG. 1 is a view of an endodontic file configured for manual manipulation by an endodontic practitioner. The file is tapered from its proximal end to its distal end and has a tip portion at the distal end.

FIG. 2 is a view of the tip portion of the endodontic file. One face surface of the tip has an arcuate-shaped portion removed as defined by radius “r”.

FIG. 2A is a cross-sectional view taken along section line 2A-2A of FIG. 2. The tip includes two triangular-shaped faces intersecting to form the center guide point of the tip. Each of the two faces is contiguous to an opposing lateral surface of a conical-shaped envelope defining the tip. The arcuate-shaped portion of the third face, however, is non-contiguous to an opposing lateral surface of the conical-shaped envelope.

FIG. 3 is a view of the file of FIG. 2 taken along section line 3-3 of FIG. 2.

FIG. 4 is a view of an endodontic file with one face of the tip having a more acute angle relative to the central longitudinal axis of the file than the other two faces. Because the first face does not extend past the central longitudinal axis of the file, the three face surfaces intersect to form a single guide point at the center of the tip.

FIG. 5 is a view of an endodontic file having a tip with a wedge-shaped portion removed from the tip.

FIG. 5A is a cross-sectional view taken along section line 5A-5A of FIG. 5. Two asymmetrical triangular-shaped faces intersect to form a single guide point at the center of the tip.

### DETAILED DESCRIPTION OF THE PREFERRED EMBODIMENTS

Preferred embodiments of an endodontic file having an improved tip configuration will now be described with reference to the drawings. Elements illustrated in the drawings are identified by the following numbers:

10 Endodontic file

12 Handle portion

14 Proximal end

16 Distal end

18 Shank working portion

20 Central longitudinal axis

22 First flute

24 Second flute

26 Third flute

30 Tip portion

32 First surface

34 Second surface

36 Third surface

38 Portion removed

40 Conical-shaped envelope

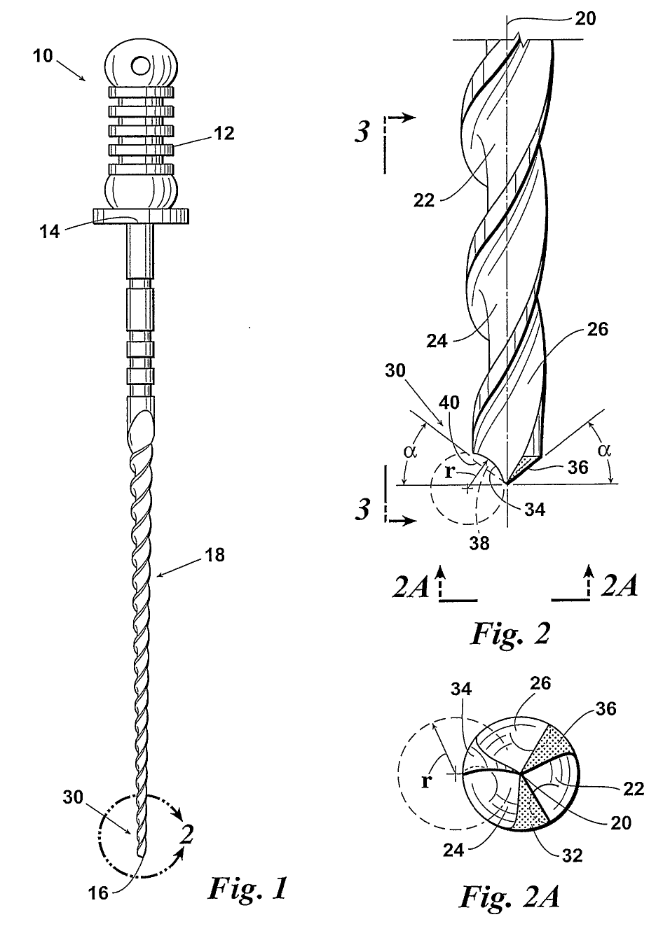

Referring to the drawings and first to FIGS. 1, an endodontic file 10 includes a handle portion 12 located at a proximal end 14 of the file with an elongated shaft working portion 18 located between proximal end 14 and distal end 16. Handle 12 is typically a small plastic handle portion configured for manual manipulation. Handle 12 may be replaced by a chuck stem (not shown) integrally formed with file 10 and configured to be received in a chuck (not shown) for mechanical manipulation. Working portion 18 includes three helical-shaped flutes 22, 24, 26 with spiraled lands therebetween. File 10 is tapered along its length so that distal end 16 is preferably of a substantially reduced diameter compared to the proximal end 14. A tip portion 30 lies at distal end 16.

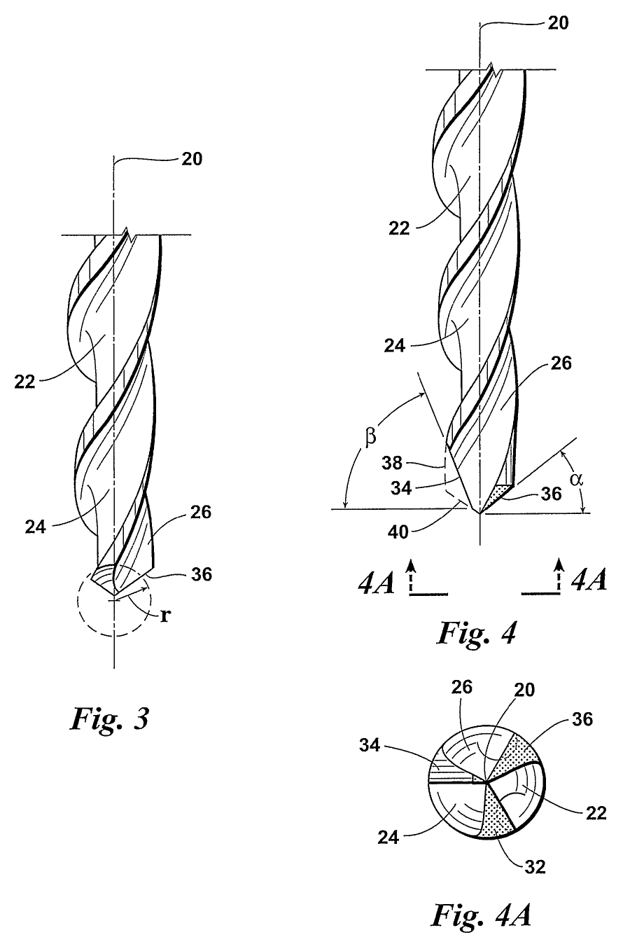

Referring to FIGS. 2 to 3, tip portion 30 is defined by a conical-shaped envelope having its apex located coaxial the central longitudinal axis 20 of file 10. The envelope is generally indicated by numeral 40. Two substantially identical, flat triangular-shaped face surfaces 32, 36 are oriented at an angle “α” relative to a line normal axis 20. Each surface 32, 36 lies substantially contiguous with an opposing lateral surface of the conical-shaped envelope 40. Similar to surfaces 32 and 36, a first portion of surface 34 is oriented at angle “α”. Unlike surfaces 32 and 36, a portion 38 of surface 34 is removed, resulting in surface 34 having an arcuate-shape of radius “r”. Preferably, removed portion 38 does not extend past the central longitudinal axis 20 of the file 10. The arcuate-shaped portion of surface 34, therefore, is no longer contiguous to the opposing lateral surface of the conical-shaped envelope 40 defining tip 30. Surfaces 32 and 36 along with the non-removed portion of surface 34—intersect to form the apex of tip 30. Surfaces 32, 34, 36 intersect to form the apex of tip 30 and, therefore, the apex of the conical-shaped envelope 40.

FIGS. 4 and 4A illustrate surface 34 having a portion of surface 34 formed by an angle “β” relative to a line normal axis 20. Preferably, removed portion 38 does not extend past the central longitudinal axis 20 of the file 10. Angle “β” is preferably greater than the angle “α” of surfaces 32 and 36. Surfaces 32 and 36 remain substantially triangular in shape and intersect to form a guide tip point at center 20. Each surface 32, 36 also remains contiguous to the opposing lateral surface of the conical-shaped envelope 40 defining the original tip 30 but no portion of surface 34 defined by angle “β” is contiguous to the opposing lateral surface of the conical-shaped envelope 40.

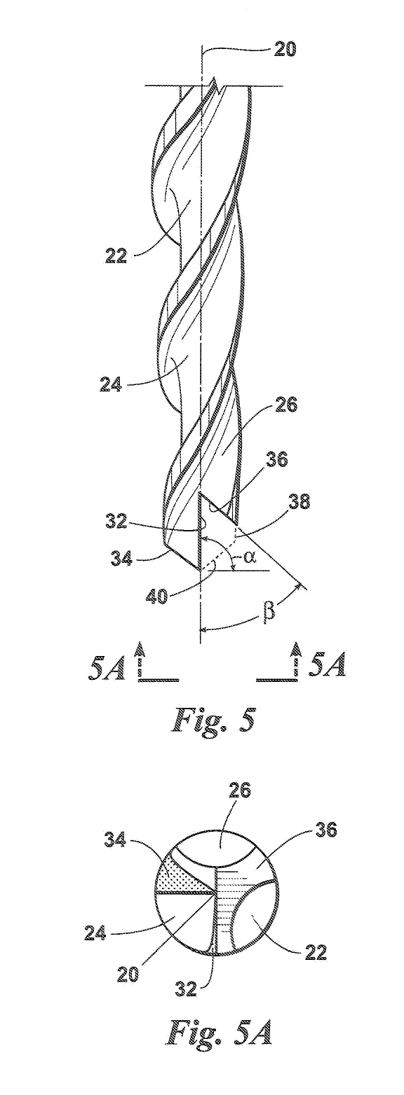

FIGS. 5 and 5A illustrate a tip 30 having a wedge-shaped portion 38 removed. Preferably, removed portion 38 does not extend past the central longitudinal axis 20 of the file 10. Portion 38 is defined by a first angle “α” and a second angle “β”. Surface 36 and a significant portion of surface 32 no longer lie contiguous to an opposing lateral surface of the conical-shaped envelope 40 defining the original tip 30. The remaining portion of surface 32 retains its general triangular shape and intersects surface 36 to form a point at the center 20 of tip 30. Each surface 32 and 36 is contiguous to an opposing lateral surface of the conical-shaped envelope 40 defining the original tip 30.

While the preferred embodiments have been described with a certain degree of particularity, the phraseology and terminology employed were for purposes of description and not limitation. Many changes may be made in the details of construction and the arrangement of components without departing from the spirit and scope of this disclosure. An endodontic file 10 according to this disclosure, therefore, is limited only by the scope of the claims, including the full range of equivalency to which each element thereof is entitled.

What is claimed is:

1. A dental instrument for cleaning and shaping a root canal of a tooth comprising:
a longitudinal body having a taper, a central axis of rotation, a plurality of helical-shaped flutes with spiraled lands therebetween, and a guide tip;
said guide tip having a plurality of face surfaces; a first face surface of said plurality of face surfaces lying substantially contiguous to a lateral surface of a conical-shaped envelope sharing an apex of said first face surface, and a portion of a second face surface of said plurality of surfaces lying noncontiguous to a lateral surface of said conical-shaped envelope; and
wherein said first and second face surfaces intersect to form a guide point at an apex of said guide tip, said guide tip being coaxial with said central axis of rotation.

2. A dental instrument according to claim 1 further comprising a portion of said second face surface defined by a radius “r”.

3. A dental instrument according to claim 1 further comprising a portion of said second face surface defined by an angle “α”.

4. A dental instrument according to claim 3 further comprising a portion of said second face surface defined by a second angle “β”.

5. A dental instrument for cleaning and shaping a root canal of a tooth comprising:
a longitudinal body having a taper, a central axis of rotation, a plurality of substantially symmetrical helical-shaped flutes with spiraled lands therebetween, and a guide tip;
said guide tip having a plurality of face surfaces and further being defined by a conical-shaped envelope coaxial said central axis of rotation;
a first face surface of said plurality of face surfaces lying substantially contiguous to a lateral surface of said conical-shaped envelope and a portion of a second face surface of said plurality of face surfaces lying noncontiguous to a lateral surface of said conical-shaped envelope; and
wherein said first and second face surfaces intersect to form a guide point at an apex of said guide tip, said guide point being coaxial with said central axis of rotation.

6. A dental instrument according to claim 5 further comprising a portion of said second face surface defined by a radius “r”.

7. A dental instrument according to claim 5 further comprising a portion of said second face surface defined by an angle “α”.

8. A dental instrument according to claim 7 further comprising a portion of said second face surface defined by a second angle “β”.

9. A dental instrument for cleaning and shaping a root canal of a tooth comprising:
a longitudinal body having a taper, a central axis of rotation, three substantially symmetrical helical-shaped flutes with spiraled lands therebetween, and a guide tip;
said guide tip having a first, second, and third face surface and further being defined by a conical-shaped envelope coaxial said central axis of rotation;
said first and second face surfaces lying substantially contiguous to a lateral surface of said conical-shaped envelope, a portion of said third face surface lying noncontiguous to a lateral surface of said conical-shaped envelope; and
wherein said face surfaces intersect to form a guide point at an apex of said guide tip, said guide point being coaxial with said central axis of rotation.

10. A dental instrument according to claim 9 further comprising a portion of said third face surface defined by a radius “r”.

11. A dental instrument according to claim 9 further comprising a portion of said third face surface defined by an angle “α”.

12. A dental instrument according to claim 11 further comprising a portion of said third face surface defined by a second angle “β”.
